(19) United States
(12) Patent Application Publication
(10) Pub. No.: US 2008/0050198 A1
(43) Pub. Date: Feb. 28, 2008

(54) Fastening element for hard constructional component

(76) Inventors: Thoms Ayrle, Langerringen (DE); Marc Schaeffer, Sigmarszell-Niederstaufen (DE)

Correspondence Address: ABELMAN, FRAYNE & SCHWAB, 666 THIRD AVENUE, 10TH FLOOR, NEW YORK, NY, 10017, US

(21) Appl. No.: 11/894,862

(22) Filed: Aug. 21, 2007

(30) Foreign Application Priority Data
Aug. 23, 2006 (DE) 10 2006 000 412.4

(51) Int. Cl. F16B 25/00

(52) U.S. Cl. 411/386

(57) ABSTRACT

A fastening element for a hard constructional component (6) includes a base body (12; 22; 42) extending along a longitudinal axis (19; 29; 49), a self-tapping thread (13; 23; 43) provided, at least regionwise, on the base body (12; 22; 42) and a height of which extends radially outwardly from the outer surface (18, 28, 48) of the base body (12; 22; 42), and at least one groove (16, 26, 45, 46, 47) provided on the base body (12; 22; 42) and a depth (T1, T2) of which extends radially inwardly from the outer surface (18; 28; 48) of the base body (12; 22; 42) and which is axially spaced from the self-tapping thread (13; 23; 43).

### BACKGROUND OF THE INVENTION

1. Field of the Invention

The present invention relates to a fastening element for a hard constructional component and including a base body extending along a longitudinal axis and having an outer surface, a self-tapping thread provided, at least regionwise, on the base body and a height of which extends radially outwardly from the outer surface of the base body. At least one groove provided on the base body and a depth of which extends radially inwardly from the outer surface of the base body.

2. Description of the Prior Art

Different types of fastening elements for hard constructional components such as concrete, masonry and the like are known fastening elements are set in preliminary formed boreholes in a constructional component percussively and/or rotary, dependent on their shape.

European Patent EP 0 623 759 B1 discloses a thread-forming screw for being screwed in a hard constructional component and having a shaft which forms a base body, and a screw head forming engagement means for a setting tool and provided at shaft end. Along the shaft, a self-tapping thread extends the height of which extends radially outwardly from the outer surface of the shaft. In order to facilitate driving of the screw in, on the base body, on both sides of the thread, there are provided circumferential grooves for receiving the broken material of the constructional component, the depth of which extends radially inwardly form the outer surface of the base body.

European Publication EP 1 536 149 A2 discloses a sleeve with an inner thread and a self-tapping thread. The sleeve has a base body with an outer surface. On the base body, regionwise, the self-tapping thread is provided the height of which extends from the outer surface of the base body radially outwardly. The sleeve further has engagement means, which is located inwardly, and a receptacle provided with an inner thread which forms load application means, and is accessible from one of the ends of the base body for insertion of a threaded rod or screw.

U.S. Pat. No. 4,350,464 discloses a percussively driven anchor rod having a shaft which forms a base body on which a self-tapping thread is provided the height of which extends from the shaft surface radially outwardly. On the anchor rod, there is also provided a thread for securing an object, e.g., with a nut to a constructional component.

The connection length of the self-tapping thread in a constructional component provides for introducing into the constructional component forces generated by application of a load to a fastening element. The load increase can be achieved by reducing the annular gap between the outer surface of the base body and a borehole wall. With as small as possible annular gap, upon setting of the fastening element, the produced drilling dust is compressed between the outer surface of the base body and the borehole wall.

The drawback of the fastening element of U.S. Pat. No. 4,350,464 consists in that the size of the annular gap between the outer surface of the base body and the borehole wall from an attachment point to an attachment point can vary greatly, dependent on the properties of the constructional component and type and condition of the tool for forming the borehole. In addition, high loads can act on undercuts in the constructional component which are produced by the thread. These loads can lead to a partial or, in the extreme case, to a complete failure of the formed attachment point. In order to prevent this and to achieve a high load-carrying capacity, such fastening elements have a relatively large connection length of the thread in the constructional component, which entails high costs for setting of a corresponding fastening element.

German Publication DE 198 20 671 A1 discloses a screw with a self-cutting thread which is set in a borehole filled with a hardenable mass. The hardenable mass is used in order to reduce the necessary connection length of the thread while retaining the possibility to use the complete load-carrying capacity of the screw to a most possible extent. The thread of this fastening element is anchored in the constructional component and the mass after hardening of the hardenable mass.

Suitable hardenable masses such as, e.g., mortar on an epoxy bases, which is known to one skilled in the art as universal mortar, have advantageously a high content of filler material that insures a high viscosity and a low shrinkage, together with an adequate stiffness of the hardened mass. The hardenable masses are generally relatively expensive. Therefore, for economical reasons, there is a need to limit to a minimum the necessary amount of the hardenable mass per attachment point.

The drawback of the solution of DE 198 20 671 A1 consists in that the gap between the outer surface of the base body and the borehole wall should have a sufficient size so that in addition to flowable masses, hardenable masses with a filling material can be used. For a complete filling of the annular gap, a sufficient amount of a hardenable mass is necessary. If a screw according to DE 198 20 671 A1 is set in a borehole without a hardenable mass, the reachable utilization of the load-bearing capacity constitutes-only a fraction of that of a conventional concrete screw.

If a conventional generic fastening element is set in a borehole which is filled with a hardenable mass, the annular gap between the outer surface of the base body and the borehole wall would be two small for most types of hardenable masses. Therefore, only simple flowable hardenable masses can be used, which are relatively expensive and have, in comparison with hardenable masses with a filling material, a smaller stiffness. In addition, the borehole must be completely cleaned from drilling dust before injection of the hardenable mass to prevent clogging of the annular gap with the drilling dust.

Accordingly, an object of the present invention is to provide a rotatably and/or percussively set table fastening element having an advantageous load-bearing performance and is suitable for use with the universal mortar.

### SUMMARY OF THE INVENTION

This and other objects of the present invention, which will become apparent hereinafter, are achieved by providing, on the base body, at least one groove axially spaced from the thread.

With a fastening element according to the present invention, the annular gap between the outer surface of a preferably cylindrical base body and the borehole wall can be small, while providing for an increased load-carrying capacity because of a compressed drilling dust. Simultaneously, by filling the borehole with a hardenable mass, the anchoring of the fastening element can be so improved that the connection length of the thread in the constructional component can be reduced. Under the outer surface of the base body, the base body surrounding surface is understood. With a cylindrical base body, the cylindrical surface forms the outer surface of the base body. The self-tapping thread ends or begins at that surface so that the thread root lies essentially on the outer surface of the base body.

The at least one groove forms a filling groove for the hardenable mass and provides sufficient space for the hardenable mass that, e.g., a two-component mortar, contains a filling material in form of particle with a predetermined size. Thereby, dependent on the requirement to the attachment point, a suitable hardenable mass for filling the annular gap between the outer surface of the base body and the borehole wall can be used. Because of the axial spacing between the at least one groove and the thread, only a small portion of the drilling dust or drillings, which are produced during tapping of the borehole wall, reaches the at least one groove, which impedes rising of the displaced portion of the hardenable mass in the at least one groove only insignificantly. On the base body, there can be provided more than one groove. The load-carrying cross-section of the base body is reduced only regionwise by the at least one groove. Therefore, despite this partial weakening of the cross-section of the base body, a high load-carrying capacity of a set inventive fastening element is insured.

A borehole, which is formed in a constructional component is filled, e.g., with mortar as a hardenable mass, and then a fastening element is rotationally and/or percussively driven in the borehole, with a displaced portion of the hardenable mass rising easily into the at least one groove. With the hardenable mass rising, the space between the fastening element and the borehole wall is filled, and the fastening element becomes formlockingly anchored in addition to being anchored by thread sections which penetrated in the constructional component. A portion of the hardenable mass that is forced out of the borehole and appears at the borehole mouth indicates to the user that the at least one groove is completely filled. The fastening element is partially loaded by the completely hardened hardenable material.

The fastening element according to the present invention can be set easily and with comparatively small force. Moreover, the inventive fastening element can be set in a previously formed borehole without the use of the hardenable mass, because a small annular gap between the outer surface of the base body and the borehole wall insures a good anchoring of the fastening element in the constructional component.

The at least one groove can be formed in the base body during rolling or with a separate manufacturing process, e.g., by machining, which enables a cost-effective manufacturing of the fastening element.

Preferably, the at least one groove extends, at least regionwise, parallel to the thread. The groove runs essentially in form of a spiral with the same pitch as the self-tapping screw, which insures an easy rise of the hardenable mass in the at least one groove in the direction of the borehole mouth.

Advantageously, the at least one groove extends, at least regionwise, parallel to the longitudinal axis of the base body, which provides for an easy rise of the displaced hardenable mass in the at least one groove in the direction of the borehole mouth.

In an advantageous embodiment of the present invention, the at least one groove extends in form of a spiral in a region of the self-tapping thread, and extends parallel to the longitudinal axis of the base body in a thread-free region of the base body. This insures a particularly easy rise of the hardenable material in the at least one groove.

Preferably, the at least one groove has a polygonal cross-section, e.g., trapezoidal or rectangular. Alternatively, the at least one groove can have a cross-section of a segment of a circle.

Advantageously, the depth of the at least one groove corresponds to from two-hundredth to five-tenth of a diameter of the base body. With such groove depth, a number of hardenable masses with large particles of a filling material can be used. Advantageously, the minimal depth of the at least one groove amounts to at least double of the size of filling material particles which are contained in the hardenable material with which the fastening element is used.

Advantageously, the width of the at least one groove, which is measured between opposite flanks of the thread, at the thread root, corresponds to from five/hundredth to five/tenth of the diameter of the base body. The groove bottom of the at least one groove extends advantageously parallel to the thread root or to the outer surface of the base body.

The depth and width of the at least one groove are selected dependent primarily on the hardenable mass to be used with the fastening element. This leads, albeit insignificantly, to reduction of the load carrying cross-section of the base body.

According to the advantageous embodiment of the invention, the base body is formed as a shaft on the outer surface of which, at least regionwise, a self-tapping thread is provided. Adjoining the self-tapping thread, a further thread, e.g., in form of a machining-thread can be provided to form an anchor bolt suitable for arrangement of a nut.

According to the invention, at one end of the shaft, there is provided engagement means for a setting tool, e.g., in form of a screw head, which enables a percussive and/or rotational setting of the inventive fastening element formed as a self-tapping screw.

According to a further advantageous embodiment of the present invention, the base body has inwardly located engagement means for a setting tool and a receptacle provided with load application means in form of an inner thread and accessible from one end of the base body.

This fastening element forms a self-tapping sleeve with an inner thread. The self-tapping thread can be formed, e.g., as a coarse thread, which permits to percussively set this fastening element.

Advantageously, the base body has a filling opening that connects the receptacle with an outer side of the base body for filling a borehole which is formed in the constructional component and in which the fastening element is to be set. Thereby, the borehole and the annular gap between the outer surface of the base body and the borehole wall can be filled with a hardenable mass after setting of the fastening element, with the mass rising in the direction of the borehole mouth through the at least one groove. Advantageously, the filling opening extends parallel to the longitudinal axis from the engagement means to the front, in the setting direction, end of the base body.

The novel features of the present invention, which are considered as characteristic for the invention, are set forth in the appended claims. The invention itself, however, both as to its construction and its mode of operation, together with additional advantages and objects thereof, will be best understood from the following detailed description of the preferred embodiments, when read with reference to the accompanying drawings.

### BRIEF DESCRIPTION OF THE DRAWINGS

The drawings show:

FIG. 1 a side view of a first embodiment of a fastening element according to the present invention;

FIG. 2 a partially cross-sectional view of the fastening element shown in FIG. 1 in the set condition;

FIG. 3 a side view of a second embodiment of a fastening element according to the present invention; and

FIG. 4 a side view of a third embodiment of a fastening element according to the present invention.

### DETAILED DESCRIPTION OF THE PREFERRED EMBODIMENT

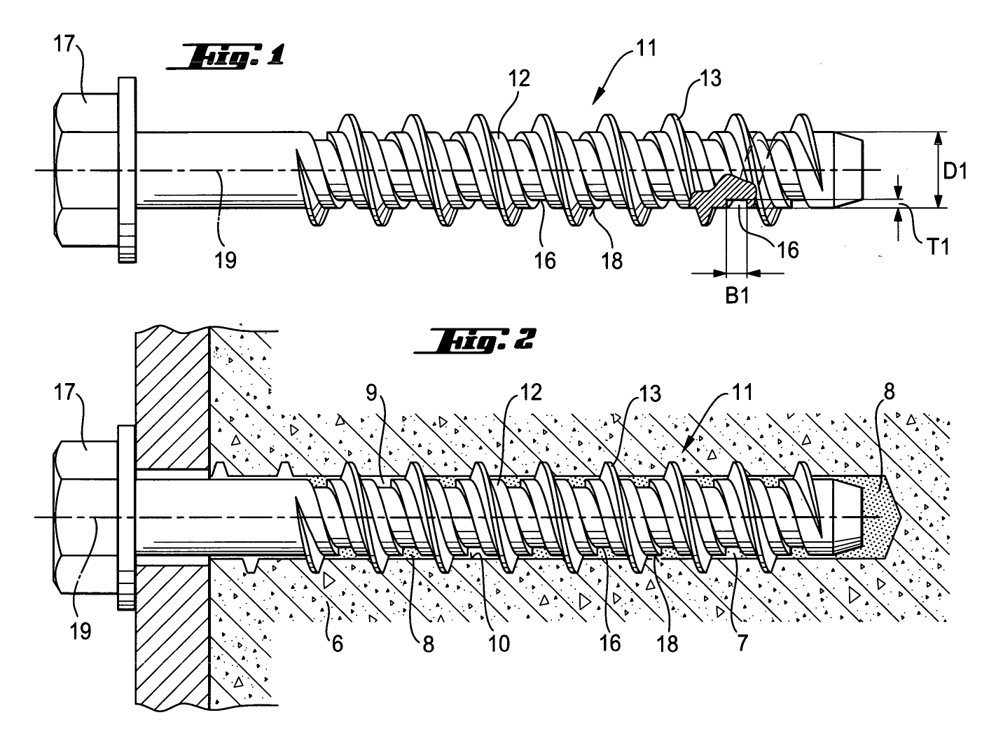

A fastening element 11 according to the present invention which is designed for use in a hard constructional component 6 such as concrete masonry and the like and which is shown in FIGS. 1-2, is formed as a concrete screw set in a borehole 7 formed in the constructional component. The fastening element 11 has a shaft that forms a base body 12 extending along a longitudinal axis 19. The base body 12 has an outer surface 18 and a hexagonal head 17 that serves as engagement means for a setting tool not shown. The fastening element 11 is set percussively and/or rotationally. On the base body 12, there is provided a self-tapping thread 13 the height of which extends radially outwardly from the outer surface 18 of the base body 12.

On the base body 12, there is further provided a groove 16 for a hardenable mass 8 and which extends parallel to the thread 13 between the separate threads and axially spaced from the threads. The groove 16 has a depth T1 that corresponds to one/tenth of the diameter D1 of the base body 12. The groove 16 extends radially inwardly from the outer surface 18 and has a polygonal cross-section. The groove 16 has a width B1 that corresponds to three/tenth of the diameter D1 of the base body 12.

The borehole 7 is filled with a certain amount of the hardenable mass 8, e.g., a two-component mortar, and then the fastening element is rotatably driven into the borehole 7. With the fastening element 11 being driven into the borehole 7, the self-tapping thread 13 forms a thread in the borehole wall 10, and the hardenable mass 8, which was injected in the borehole 7 previously, is partially displaced. The displaced portion of the hardenable mass 8 fills the groove 16 and the space 9 between the fastening element 11 and the borehole wall 10. The fastening element 11 is anchored in the constructional component 6 on one hand, by the self-tapping thread 13 and, on the other hand, by the hardenable mass 8.

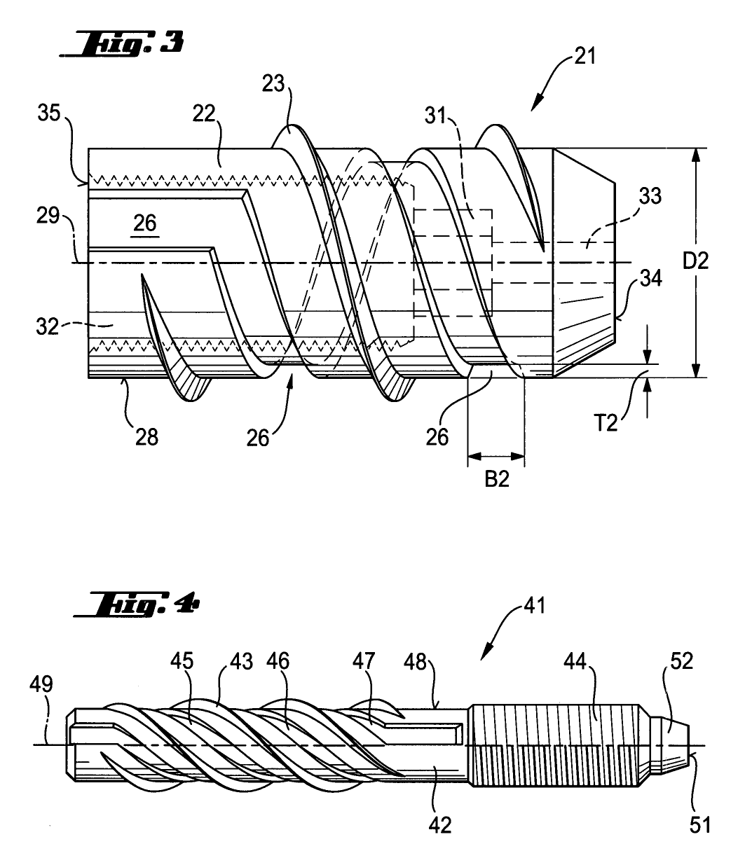

A fastening element 21 according to the present invention for a hard constructional component, which is shown in FIG. 3, is formed as a sleeve with an inner thread and has a cylindrical base body 22 that extends along the longitudinal axis 29 and has an outer surface 28. On the base body 22, there is provided a self-tapping thread 23 the height of which extends radially outwardly from the outer surface 28 of the base body 22. The base body 22 has an inwardly located engagement means 31 adjoining it, receptacle 32 extending from an end 35 of the base body 22 and provided with an inner thread that serves as load application means for a threaded rod, not shown, or a screw. There is further provided a filling bore 33 that extends from the engagement means 31 up to the front end 34 of the base body 22.

On the base body 22, there is further provided a groove 26 which is axially spaced from the thread 23 and, extends in form of a spiral in a region of the thread 23 and parallel to the thread 23, and extends parallel to the longitudinal axis 29 of the base body 22 in the thread-free region of the base body 22. The groove 26 extends with a depth T2, which corresponds to seven/hundredth of the diameter D2 of the base body 22, radially inwardly from the outer surface 28 of the base body 22 and has a slightly trapezoidal cross-section. The groove 26 has a width B2 that corresponds to thirty-five/hundredth of the diameter D2 of the base body 22.

The fastening element 21 is rotatably driven, e.g., in a borehole, and the self-tapping screw 23 forms a thread in the borehole wall for being anchored thereby therein. Then, a hardenable mass is brought through the filling opening 33 in the base body 22, filling the remaining space in the borehole. The hardenable mass is brought into the borehole until a portion of the mass exits the borehole. The groove 26 in the base body 22 insures ascending of the hardenable mass during filling of the borehole.

A fastening element 41 for a hard constructional component, which is shown in FIG. 4 and is formed as an anchor rod, has a shaft forming a base body 42 that extends along a longitudinal axis 49 and has an outer surface 48. On the base body 42, there is provided a self-tapping thread 43 the height of which extends radially outwardly from the outer surface 48 of the base body 42, and a further thread 44 for securing an object, not shown, with a nut likewise not shown. The self-tapping thread 43 is formed as a multistart coarse thread that provides for a percussive setting of the fastening element 41. At one end of the base body 42, there is provided engagement means 52 for a setting tool, not shown. On the base body 42, in the region of the thread 43, there are provided grooves 45, 46, 47 which extend in form of spiral in the region of the self-tapping thread 43 between the threads and axially spaced therefrom, and extend parallel to the longitudinal axis 49 in the thread-free regions of the base body 42. The depth of the grooves 45, 46, 47 extend from the outer surface 48 of the base body 42 radially inwardly.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A fastening element for a hard constructional component (6), comprising a base body (12; 22; 42) extending along a longitudinal axis (19; 29; 49) and having an outer surface (18; 28; 48); a self-tapping thread (13; 23; 43) provided, at least regionwise, on the base body (12; 22; 42) a height of which extends radially outwardly from the outer surface (18, 28, 48) of the base body (12; 22; 42); and at least one groove (16; 26; 45, 46, 47) provided on the base body (12; 22; 42) and a depth (T1, T2) of which extends radially inwardly from the outer surface (18; 28; 48) of the base body (12; 22; 42), and which is axially spaced from the self-tapping thread (13; 23; 43).

2. A fastening element according to claim 1, wherein the at least one groove (16; 26; 45, 46, 47) extends, at least regionwise, parallel to the thread (13; 23; 43).

3. A fastening element according to claim 1, wherein the at least one groove (26; 45, 46, 47) extends, at least regionwise, parallel to the longitudinal axis (29; 49) of the base body (22; 42).

4. A fastening element according to claim 1, wherein the at least one groove (16; 26; 45, 46, 47) has a polygonal cross-section.

5. A fastening element according to claim 1, wherein the depth (T1; T2) of the at least one groove (16; 26) corresponds to from two/hundredth to five/tenth of a diameter (D1; D2) of the base body (12; 22).

6. A fastening element according to claim 1, wherein the width (B1; B2) of the at least one groove (16; 26) corresponds to from five/hundredth to five/tenth of a diameter (D1; D2) of the base body (12; 22).

7. A fastening element according to claim 1 wherein the base body (12; 42) is formed as a shaft.

8. A fastening element according to claim 7, comprising engagement means (17; 52) for a setting tool and which is provided at an end of the shaft.

9. A fastening element according to claim 1 wherein the base body (22) comprises inwardly located engagement means (31) for a setting tool and a receptacle (32) provided with load application means and accessible from one end (35) of the base body (22).

10. A fastening element according to claim 9, wherein the base body (22) comprising a filling opening (33) that connects the receptacle (32) with an outer side of the base body (22) for filling a borehole (7) which is formed in the constructional component (6) and in which the fastening element (21) is to be set.
